(19) United States
(12) Patent Application Publication
(10) Pub. No.: US 2019/0091000 A1
(43) Pub. Date: Mar. 28, 2019

(54) METHOD FOR POLYMERIZING DENTAL POLYMERIZATION COMPOSITE RESIN, AND LIGHT IRRADIATING DEVICE

(71) Applicant: Kulzer GmbH, Hanau (DE)

(72) Inventors: Harald Kubiak-Essmann, Nidderau (DE); Stephan Schmid, Glauburg (DE); Patrick Niedoba, Goldbach (DE); Christian Weigel, Grosskrotzenburg (DE)

(21) Appl. No.: 16/094,216

(22) PCT Filed: Apr. 12, 2017
(86) PCT No.: PCT/EP2017/058858

§ 371 Date: Oct. 17, 2018

(30) Foreign Application Priority Data
Apr. 18, 2016 (DE) 10 2016 107 122.6

(51) Int. Cl. A61C 13/15; C08F 2/50; B01J 19/12; B01J 19/00; A61C 13/08; A61C 13/087; A61C 13/09; A61C 13/00

(52) U.S. Cl. CPC A61C 19/003; C08F 2/50; B01J 19/123; B01J 19/0033; B01J 19/0013; B01J 2219/1203; A61C 13/087; A61C 13/09; A61C 13/0006; B01J 2219/0801; B01J 2219/0871; A61C 13/082

(57) ABSTRACT

The invention relates to a method for polymerizing and curing a dental polymerization composite resin using a light irradiating device, said light irradiating device comprising at least one blue LED with an emission peak at a wavelength between 430 nm and 490 nm and at least one ultraviolet or near-UV LED with an emission peak between 350 nm and 420 nm, the at least one blue LED is first operated without the at least one ultraviolet or near-UV LED, and the at least one ultraviolet or near-UV LED is operated later, wherein the power of the at least one blue LED and the power of the at least one ultraviolet or near-UV LED are controlled in a programmed manner based on time, and the light irradiated from the at least one blue LED and the at least one ultraviolet or near-UV LED of the light irradiating device is irradiated onto the dental polymerization composite resin, wherein the dental polymerization composite resin is thereby polymerized and cured.

The invention also relates to a light irradiating device for polymerizing and curing a dental polymerization composite resin, said light irradiating device having at least one blue LED with an emission peak at a wavelength between 430 nm and 490 nm and at least one ultraviolet or near-UV LED (2) with an emission peak between 350 nm and 420 nm, and a controller for temporally controlling the power of the at least one blue LED and for temporally controlling the power of the at least one ultraviolet or near-UV LED independently of each other, wherein the controller is designed, in particular programmed, to carry out such a method.

The invention relates to a method for polymerizing and curing dental polymerization composite resin as well as a light irradiating device for carrying out such a method. The method and the light irradiating device are deployed in laboratories where dental protheses and complete dentures are produced.

Dental photopolymerization composite resins or respectively dental polymerization composite resins for short are widely used in dental medicine. In addition to the good physical properties, these materials are also particularly suitable since they do not cause an unpleasant feeling in the mouth compared with natural teeth, and since their color can be adapted to the shade of natural teeth so that the necessary aesthetic properties can also be attained.

In order to use the dental polymerization composite resins, these are polymerized and cured following shaping of parts of dentures such as dental protheses or parts of a dental prothesis, for example, from the dental polymerization composite resin. The polymerization and hardening, or respectively curing, is usually carried out by means of light with the aid of so-called polymerization units which contain suitable light irradiating devices.

In order to subject the currently used dental polymerization composite resins to photopolymerization, a combination of a camphorquinone and a tertiary amine or an acylphosphine oxide is most frequently used as the photopolymerization catalyst. The camphorquinone has an optical absorption wavelength band with a maximum of approximately 460 nm and a range of approx. 30 nm around the maximum.

Halogen lamps irradiate light in a broad light wavelength range between 350 nm and 800 nm. The wavelengths of the light which are not suitable for photopolymerization of the dental polymerization composite resin are simply filtered out. As a result, 90% of the irradiated energy is already lost. Moreover, halogen lamps have a reduced light quantity during normal use.

In order to overcome these disadvantages, the application of laser light having a high intensity has been discussed (see, for example, the patent U.S. Pat. No. 6,282,012 B1). Initial light irradiating devices with LEDs as the illuminant have additionally been developed. A plurality of Light-Emitting Diodes (LEDs) with an emission peak in the range of 430 to 480 nm (so-called blue LEDs) is mostly deployed. These are used with an optical apparatus for bundling the light of the diodes in the light irradiating devices.

Light irradiating devices having a blue LED and having a high intensity have a low penetration depth into the dental polymerization composite resin compared with photopolymerization with halogen lamps, as a result of which a high, not completely polymerized proportion of dental polymerization composite resin remains in the interior. This can therefore result in an impairment of the material properties of the cured dental polymerization composite resin, so that the material produced from the dental polymerization composite resin can come loose from the dentures just a short time after the polymerization, or respectively dentures produced therefrom have disadvantageous mechanical properties. The photopolymerization initiator is additionally a material for which the corresponding optical wavelength range has an absorption maximum (or respectively a peak) of 380 nm, which differs from camphorquinone, for which the corresponding peak is 470 nm.

In order to achieve this wavelength range, WO 00/67 048 A2 proposes a light irradiating device which comprises a light diode light source which is in the form of an array of diode elements such as e.g. laser diodes or light-emitting diodes (LED). The diode element preferably emits either in the blue or ultraviolet range of the optical spectrum. A light irradiating device, in which both a blue and an ultraviolet LED can be operated, is known from EP 1 336 389 B1. Such light irradiating devices are used for curing plastic fillings, that is to say they are deployed directly by dentists.

The disadvantage of the known light irradiating devices having LEDs and of the known methods for polymerizing and curing dental polymerization composite resins is that whilst it is true that these are suitable for curing plastic fillings, they are only of limited suitability during the manufacture of dentures on a laboratory scale. In this case, it is disadvantageous that the dental polymerization composite resins do not completely cure during the polymerization and curing during the manufacture of dentures on a laboratory scale and, therefore, the quality of the manufactured dental products is capable of improvement. In addition, it is always desirable to make the duration of the method or respectively of the curing of the dental polymerization composite resin as short as possible. The stability and color of the dental polymerization composite resin is, in this case, to be adversely affected as little as possible.

The object of the invention is thus to overcome the disadvantages of the prior art. In particular, the aim is to provide a method and a light irradiating device with which the dental polymerization composite resin is polymerized and cured as quickly, as homogeneously and as completely as possible, without thereby adversely affecting the coloring of the dental polymerization composite resin. The light irradiating device and the method for manufacturing dental products and dentures are to be deployable on a laboratory scale. The aim is to also develop a light irradiating device and a method for different and variable dental photopolymerization composite resins using a combination of camphorquinone and a photopolymerization catalyst with which the different dental photopolymerization composite resins can be efficiently and completely polymerized and cured by means of light irradiation.

The method is to be quickly and inexpensively realizable and should reduce the energy consumption as much as possible in the process. The method and the light irradiating device are to preferably be deployable in variable ways and also usable for future dental photopolymerization composite resins, the composition and behavior of which during polymerization and curing are not yet precisely known. Uniform polymerization and curing which are as extensive as possible are to be achievable, including if at all possible in the deeper, inner regions of the dental photopolymerization composite resin to be polymerized and to be cured, such that the dentures manufactured from the dental photopolymerization composite resin are as stable as possible and have homogeneous physical properties.

The objects which form the basis of the present invention are achieved by a method for polymerizing and curing a dental polymerization composite resin using a light irradiating device, said light irradiating device comprising at least one blue LED with an emission peak at a wavelength between 430 nm and 490 nm and at least one ultraviolet or near-UV LED with an emission peak between 350 nm and 420 nm, in which the at least one blue LED is first operated without the at least one ultraviolet or near-UV LED, and the at least one ultraviolet or near-UV LED is operated later, wherein the power of the at least one blue LED and the power of the at least one ultraviolet or near-UV LED are controlled in a programmed manner based on time, and the light irradiated from the at least one blue LED and the at least one ultraviolet or near-UV LED of the light irradiating device is irradiated onto the dental polymerization composite resin, wherein the dental polymerization composite resin is thereby polymerized and cured.

Here, an emission peak denotes a local maximum of the emitted electromagnetic radiation in the associated visible and ultraviolet wavelength range, that is to say for example in the range between 300 nm and 750 nm.

According to the invention, no laser diodes are preferably used as LEDs since these are more expensive and have to be cooled in a more elaborate manner.

It can be provided in methods according to the invention that the programmed controller produces a software-modulated and/or a hardware-modulated power control of the at least one blue LED and/or of the at least one ultraviolet or near-UV LED.

As a result, the control of the time-dependent power of the at least one blue LED and of the at least one ultraviolet or near-UV LED can be easily carried out or respectively realized. In this case, a software-modulated power control is preferred, since this can be easily adapted to future tasks by means of a software update.

In the case of a hardware-modulated power control, the LEDs are switched on or off in a controlled manner via relays or similar components, for example a power control, by means of binary switching on or off of individual LEDs, by means of a pacing or a step amount based on the number of the LEDs which are wired up.

In the case of a software-modulated power control, the supply voltage and/or the current flow of the LEDs is/are varied, as a result of which any infinitely variable emitted power curve or ramp (dimmer principle) or respectively frequency (stroboscope principle) or similar can be represented.

Furthermore, it can be provided that the at least one blue LED and/or the at least one ultraviolet or near-UV LED is/are operated periodically at least at times, wherein the frequency is preferably controlled in a programmed manner.

As a result, a pulse width modulation can be produced for example, with which a power input which is adapted to the dental polymerization composite resin can be achieved in a simple way.

As a result, particularly preferable methods according to the invention can also be distinguished in that the power of the at least one blue LED and/or of the at least one ultraviolet or near-UV LED is increased and/or reduced in a controlled manner based on time by means of at least one power ramp, wherein the power is preferably increased or reduced within a period of at least 1 second and a maximum of 300 seconds from a first power to a second power and/or the at least one power ramp is controlled with a linear, logarithmic or exponential time-dependent course or with a passage of time which follows another mathematical function.

In the case of the power ramp, a ramp is preferably used according to the invention in which the power is increased or reduced within at least 1 second and a maximum of 300 seconds. Thanks to the power ramps, the dental polymerization composite resin can be successfully polymerized and cured uniformly or respectively homogeneously, even in deeper regions. This is particularly the case at the start of the irradiation of the dental polymerization composite resin with the light of the blue LEDs. The power at the start of the irradiation is therefore very particularly preferably increased, uniformly or in accordance with a particular function, from zero to a first nominal power.

It is proposed with a further development of the method according to the invention and the light irradiating device according to the invention which is described below that the program for temporally controlling the power of the at least one blue LED and/or of the at least one ultraviolet or near-UV LED is started by operating an operating element of the light irradiating device or of an input device or of a computer which is connected to the light irradiating device or which is a part of the light irradiating device, in particular started by operating a switch, a button, a keyboard, a rotary pulse generator, a touchscreen, voice control or a lever of the light irradiating device or of the computer.

A smartphone can also be used as a computer, which can select and start programs by means of a suitable app. New programs for controlling the power of the at least one blue LED and/or of the at least one ultraviolet or near-UV LED can preferably be stored or respectively loaded in a programmable electronic memory of the light irradiating device, or existing programs can be modified or deleted, via the app. The computer or the smartphone can also be directly used to control the power of the LED. In this case, the computer or the smartphone is then to be understood as an essential part of the light irradiating device, since it is programmed to carry out the essential parts of the method according to the invention. A high degree of user friendliness is achieved thanks to all of these indicated measures. In addition, the light irradiating device remains adaptable in this way.

It can preferably be provided that, in order to polymerize and cure the dental polymerization composite resin, a camphorquinone and a tertiary amine or an acylphosphine oxide or diphenyl(2,4,6-trimethylbenzoyl) phosphine oxide (TPO) or 1-phenylpropane-1,2-dione (PPD) is/are used as the photopolymerization catalyst of the dental polymerization composite resin. The photoinitiators TPO (diphenyl(2,4,6-trimethylbenzoyl) phosphine oxide) and PPD (1-phenylpropane-1,2-dione) have an absorption maximum of approx. 380 nm with a width of the absorption band of approx. 30 nm. This wavelength band is visible light in the blue range as well as invisible light in the near-ultraviolet and ultraviolet range.

These chemicals are particularly well suited to use with the currently used dental polymerization composite resins.

In order to make it possible to adapt to different dental polymerization composite resins, it can be provided that a plurality of different programs for temporally controlling the power of the at least one blue LED and of the at least one ultraviolet or near-UV LED are deposited or stored in the light irradiating device, and a program is selected by an input, by operating an operating element, by scanning a code or a label and/or by a measurement with at least one sensor, wherein the measurement is preferably effected with at least one sensor by means of an analysis of the dental polymerization composite resin or of at least one of its components.

As a result, the method is particularly adaptable and is suitable for polymerizing and curing different dental polymerization composite resins. Many different dental polymerization composite resins can then be easily polymerized and cured with the method.

It can also be provided that the power of the at least one blue LED and/or of the at least one ultraviolet or near-UV LED is controlled with a programmed pulse width modulation.

As a result, the power or respectively the light quantity introduced into the dental polymerization composite resin can be controlled and adjusted particularly simply.

According to a particularly preferable further development of the invention, it can be provided that the power of the at least one blue LED and the power of the at least one ultraviolet or near-UV LED are controlled in a programmed manner based on time in such a manner that the operation of the at least one blue LED starts first and the operation of the at least one ultraviolet or near-UV LED starts thereafter and the operation of the at least one blue LED is ended prior to or at the same time as the operation of the at least one ultraviolet or near-UV LED.

As a result, the curing of the dental polymerization composite resin can be further optimized.

It can additionally be provided that the light irradiating device has at least one fan for air cooling of the LED, preferably has one fan for air cooling of the at least one blue LED, and has a fan for air cooling of the at least one ultraviolet or near-UV LED, wherein the at least one fan is driven by at least one motor which is controlled in a programmed manner similarly to the controller of the power of the at least one blue LED and/or of the at least one ultraviolet or near-UV LED.

As a result, targeted heat dissipation of the LED can take place during the operation thereof and consequently the noise pollution and the energy consumption can be reduced. In addition, the user can acoustically identify from the noise of the fan which program is running and the stage of the program it is at.

It can also be provided that the light irradiating device has a motor for rotating a rotary plate, wherein the rotary plate is arranged in the irradiation region of the light irradiating device and the dental polymerization composite resin is arranged on the rotary plate in order to cure it, and wherein the motor for rotating a rotary plate is preferably controlled in a programmed manner.

The dentures to be produced or respectively the dental polymerization composite resin can be positioned on the rotary plate in order to cure it or respectively cure them in the light of the light irradiating device. As a result, a more homogeneous and more uniform light irradiation can be achieved in the dental polymerization composite resin to be cured.

It is furthermore proposed according to the invention that at least two different nominal powers greater than 0 Watt are adjusted during the programmed control of the power of the at least one blue LED and/or of the at least one ultraviolet or near-UV LED. The at least two nominal powers are preferably held for at least one second, particularly preferably held between one and 300 seconds or respectively at most until the end of program.

In this way, an improvement is achieved during the polymerization and curing in that in the course of the polymerization and curing during the program, the power of the at least one blue LED and/or of the at least one ultraviolet or near-UV LED is adapted to the ongoing polymerization and curing, so that an improvement in the homogeneity of the produced material and an optimization of the method with respect to expenditure of time and energy consumption become possible.

It can furthermore be provided that at least a part of the light of the at least one blue LED and/or of the at least one ultraviolet or near-UV LED which does not directly hit the dental polymerization composite resin is irradiated with the aid of a reflector or with the aid of a plurality of reflectors onto the dental polymerization composite resin.

As a result, the proportion of the light quantity produced by the LED which is actually used can be increased. In addition, due to the irradiation of the light from different directions a more uniform and, if applicable, deeper input of the light into the dental polymerization composite resin to be cured is achieved.

It is proposed with a further development of the method according to the invention that the light irradiating device has an irradiation opening for irradiating the light of the at least one blue LED and of the at least one ultraviolet or near-UV LED having an area of at least 10 cm², preferably 100 cm². The term ‘irradiation opening’ according to the invention also means a sum of multiple irradiation openings.

As a result, a more uniform irradiation of the dental polymerization composite resin to be cured is achieved and, in addition, the use for larger dentures such as, for example, a full prothesis, or also for a simultaneous curing of multiple dental protheses is made possible.

According to the invention, it can also be provided that the dental polymerization composite resin is arranged on a carrier element and the dental polymerization composite resin located on the carrier element is irradiated with the light irradiating device, wherein a dental model or a framework is preferably used as the carrier model.

The dental polymerization composite resin for curing can, on the one hand, be fashioned into the desired form and, on the other hand, can be brought into a particularly well-suited position within the light irradiating device with the aid of the carrier element.

According to the invention, it can preferably additionally be provided that the at least one blue LED is first operated without the at least one ultraviolet or near-UV LED, and the at least one ultraviolet or near-UV LED is switched on later, so that the at least one blue LED and the at least one ultraviolet or near-UV LED are operated at the same time at least at times as of a later point in time.

As a result, it is achieved that the time which is necessary for curing the dental polymerization composite resin is as short as possible. The light of the blue LEDs is initially used in order to reach the deeper regions of the dental polymerization composite resin and the outer regions are quickly cured with the ultraviolet or near-UV LED later.

The objects which form the basis of the present invention are also achieved by a light irradiating device for polymerizing and curing a dental polymerization composite resin, said light irradiating device having at least one blue LED with an emission peak at a wavelength between 430 nm and 490 nm and at least one ultraviolet or near-UV LED with an emission peak between 350 nm and 420 nm, and a controller for temporally controlling the power of the at least one blue LED and for temporally controlling the power of the at least one ultraviolet or near-UV LED independently of each other, wherein the controller is designed, in particular programmed, to carry out a method according to the invention.

The at least one ultraviolet or near-UV LED preferably works in the near-ultraviolet wavelength range.

In methods according to the invention, it can be provided that the light irradiating device has at least two blue LEDs with an emission peak at a wavelength between 430 nm and 490 nm and the light irradiating device has at least twice as many of the at least two blue LEDs as the at least one ultraviolet or near-UV LED, preferably has at least four times as many of the at least two blue LEDs as the at least one ultraviolet or near-UV LED.

As a result, it is achieved that the intensity of the blue light of the blue LEDs which are important for the polymerization and curing of the deeper regions of the dental polymerization composite resin can be set to a particularly high adjustment. As a result, a polymerization can also be initiated with a greater dispersion in regions which are located further inward or respectively deeper.

Furthermore, it can be provided that the at least one blue LED is constructed as multiple groups of two to twenty series-connected blue LEDs and the at least one ultraviolet or near-UV LED is constructed as at least one group of two to twenty series-connected ultraviolet or near-UV LEDs. Of course, this requires the light irradiating device to have at least two blue LEDs and at least two ultraviolet or near-UV LEDs.

Sufficiently high intensities of the blue and ultraviolet light can be achieved with this construction. In addition, the intensity of the LEDs can be easily controlled by switching on or respectively switching off entire groups and the LEDs are thereby operated at full power and, therefore, maximum efficiency.

The invention is based on the surprising discovery that an optimization of the polymerization and curing of the dental polymerization composite resin can be successfully achieved by controlling the power of the at least one blue LED and of the at least one ultraviolet or near-UV LED in a programmed way, so that homogeneous and sufficient polymerization and curing of the produced material can be achieved even at greater depths. At the same time, the method can be carried out in a time-efficient or respectively time-saving manner and cost-effectively and energy-efficiently. Thanks to the adaptability of the method according to the invention and of the device according to the invention, it is in addition possible to adapt the method and the device to different dental polymerization composite resins, including those newly developed in future, and to achieve an optimization of the polymerization and curing for these.

Within the framework of the present invention, the physical background was surprisingly found that, in the case of a few dental polymerization composite resins, the light of the at least one ultraviolet or near-UV LED is dispersed more strongly, so that the regions of the dental polymerization composite resin to be cured which are located deeper or respectively further inward polymerize and cure less strongly and less rapidly, and that this principle is applicable to the processes during the curing of dental polymerization composite resins for manufacturing dentures. It is therefore achieved by the sequence of the irradiation according to the invention that the regions of the dental polymerization composite resin to be cured which are located deeper or further inward are initially polymerized and cured with the aid of the blue light of the at least one blue LED and, subsequently, a stronger and more rapid curing takes place with the aid of the at least one ultraviolet or near-UV LED. Thus, uniform and homogeneous curing and polymerization of the dental polymerization composite can be achieved even deep down. The material produced is then more stable and the compound produced with the material has a longer life than without the measure according to the invention.

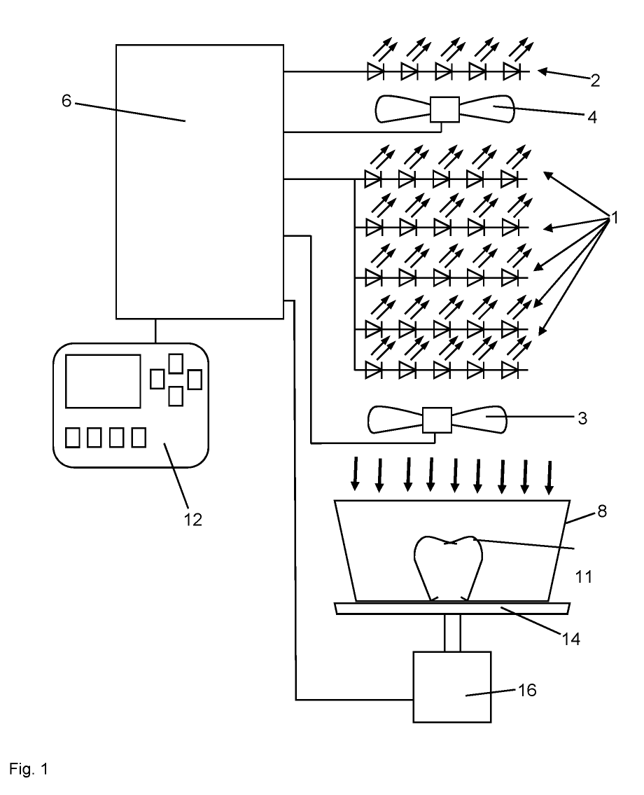

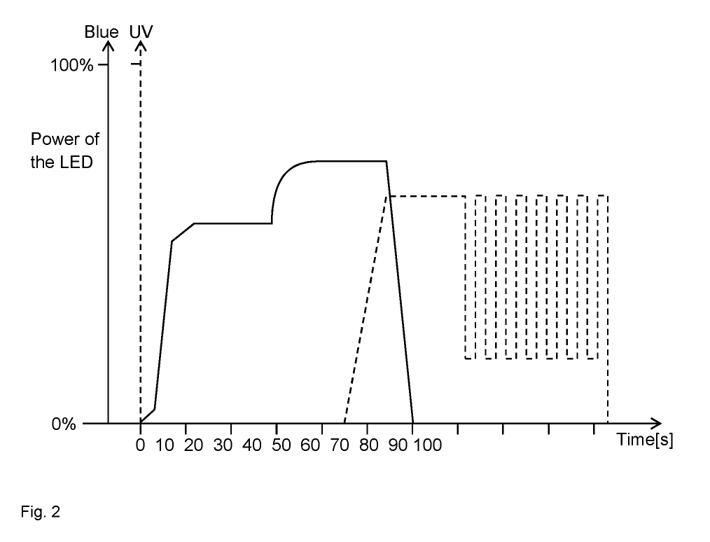

Embodiment examples of the invention are explained below with reference to a schematically represented figure and a power-time diagram without, however, limiting the invention in the process. In this case, FIG. 1 shows a schematic representation of a light irradiating device according to the invention and the power-time diagram according to FIG. 2 shows an power control of the blue and ultraviolet or near-UV LEDs according to the invention in accordance with a method according to the invention.

The light irradiating device has five groups of five blue LEDs 1 each, the irradiation of which has an emission peak at a wavelength between 430 nm and 490 nm. The five groups of the blue LEDs 1 can preferably be switched on and off in groups, in order to adjust the power of the blue LEDs 1.

Two to five groups of two to five blue LEDs each or an individual group or only one individual blue LED can alternatively be used as well within the framework of the invention.

The light irradiating device has a group of five near-ultraviolet LEDs 2 as well, the irradiation of which has an emission peak between 350 nm and 420 nm. This is only one example and more or less near-ultraviolet or UV-LEDs can also be used. The near-ultraviolet LEDs 2 and the blue LEDs 1 can each be cooled with a separate fan 3, 4. The fans 3, 4 are driven with the aid of motors. It is also possible to cool all of the LEDs 1, 2 with just a single fan 3. The cooling is effected by an air flow which washes around the LEDs 1, 2. Alternatively, cooling with a liquid coolant and/or cooling with the aid of Peltier elements is also possible.

The LEDS 1, 2 and the fans 3, 4 or respectively the motors of the fans 3, 4 are separately actuatable by means of a microcontroller 6 such as, for example, a stored-program control (SPC). In a reflector pot 8, which contains a dental polymerization composite resin 11 to be cured, the dentures to be produced are cured with the aid of irradiation by the LEDs 1, 2. The reflector pot 8 is equipped with reflectors on the inner side, which reflectors reflect the light irradiated by the LEDs 1, 2 and thus irradiate on all sides onto the dentures or respectively the dental polymerization composite resin 11 to be produced. In order to further improve the uniformity, the reflector pot 8 is arranged on a rotary plate 14 which is driven by a motor 16. The motor 16 for rotating the rotary plate 14 is controlled by the microcontroller 6. The microcontroller 6 is able to actuate the LEDs 1, 2 and the fans 3, 4 as well as the motor 16 with e.g. a phase width modulation (PWM).

According to the invention, the light irradiating device is suitable for optimized polymerization and curing of different dental polymerization composite resins 11. To this end, multiple program sequences, by means of which the power of the blue LEDs 1 and the power of the near-ultraviolet LEDs 2 as well as the engine speed of the motors of the fans 3, 4 and the engine speed of the motor 16 for rotating the rotary plate 14 can be temporally controlled, are stored in the microcontroller 6. The program can be selected, for example, by means of a computer 12 or an input device 12. It is also possible that a bar code on a packaging of the dental polymerization composite resin 11 to be polymerized and to be cured is read in with the computer 12, and the computer 12 automatically selects the appropriate program for polymerizing and curing the dental polymerization composite resin 11 identified by the bar code on the same. It is also possible to establish the type of dental polymerization composite resin 11 with the aid of sensors which are connected to the computer 12 and to start the appropriate program in the microcontroller 6 depending on the evaluation. The computer 12 or respectively the input device 12 can be connected by means of a cable, network or a wireless connection such as, for example, ethernet, WLAN, Bluetooth, USB, to the microcontroller 6, so that the information for inputting or respectively for selecting the program is conducted to an input of the microcontroller 6, and the desired program for controlling the LEDs 1, 2 in the microcontroller 6 is selected. The microcontroller 6 then starts the selected program, wherein it is also possible to wait for a start command of the input device 12 or respectively of the computer 12 for this purpose.

However, the program can also additionally or alternatively be selected based on the strength or respectively the geometrical dimensions of the dental polymerization composite resin 11 to be polymerized and to be cured.

The programs which are stored in the microcontroller 6 for temporarily controlling the power of the LEDS 1, 2 differ in particular in that they control the power of the blue LEDs 1 and of the near-ultraviolet LEDs 2 based on time. The blue LEDs 1 and the near-ultraviolet LEDs 2 are thereby operated differently. In particular, ramps are deposited in the programs, with which ramps the power of the blue LEDs 1 and of the near-ultraviolet LEDs 2 are increased and/or reduced based on time.

According to the invention, the blue LEDs 1 are preferably operated first, in order to initially polymerize and harden the regions which are located deeper in the dental polymerization composite resin 11 with the aid of the blue light. The regions of the dental polymerization composite resin 11 located closer to the surface are subsequently irradiated with the aid of the near-ultraviolet LEDs 2 and, as a result, are polymerized and cured.

These programming possibilities make it possible to cure the dental polymerization composite resin 11 in the best possible way, based on the composition thereof and/or the geometrical dimensions thereof.

FIG. 2 represents one exemplary temporal course of the power of a group of blue LEDs 1 and a group of ultraviolet (UV) LEDs 2, which are operated in accordance with a method according to the invention, in the form of a power-time diagram. The power axes of the blue LEDs 1 and of the UV LEDs 2 are linear and run from 0% to 100% of the maximum power of the LEDs 1, 2. The power axis of the blue LEDs 1 and the course of the curve for the blue LEDs 1 are represented in FIG. 2 by continuous lines, whilst the dashed power axis and the dashed power curve refer to the UV LEDs 2, the dashed curve therefore represents the temporal course of the power of the UV LEDs 2.

The power of the blue LEDs 1 (represented in FIG. 2 as a continuous line) is initially brought with a ramp, which has three different linear increases in power, to a first power (nominal power) and is operated there with this first power for approximately 18 seconds. During this time, the blue light of the blue LEDs 1 can also penetrate the deep regions of the dental polymerization composite resin 11 and initiate the desired polymerization and curing of the dental polymerization composite resin 11 there. Subsequently, the power of the blue LEDs 1 is again increased with the aid of an inversely exponential ramp to a second power (nominal power) and is held there again for approximately 15 seconds. As a result of this second increase in power, the starting polymerization can be accelerated somewhat. During this, the power of the UV LEDs 2 is increased along a linear ramp. On achieving the first nominal power of the UV LEDs 2, the power of the blue LEDs 1 is reduced with a linear ramp to zero. This therefore results in a short temporal overlap, in which both the blue LEDs 1 and the UV LEDs 2 are operated at the same time. The blue LEDs 1 are preferably operated first according to the invention, because the UV light of the UV LEDs 2 disperses more strongly on the material surface of the dental polymerization composite resin 11 and, as a result, cures and polymerizes the latter. However, following the curing and polymerization of the dental polymerization composite resin 11, this is less transparent for the irradiation of the UV LEDs 2 and also of the blue LEDs 1, so that the irradiation can no longer penetrate as deeply into the dental polymerization composite resin 11. Since the blue light of the blue LEDs 1 has a larger penetration depth due to the lower dispersion, a quicker or respectively more extensive curing and polymerization, even at greater depths of the dental polymerization composite resin 11, can be achieved by the indicated sequence according to the invention. The regions at the surface can subsequently be quickly and efficiently cured with the aid of the UV LEDs 2.

The power of the UV LEDs 2 is held at the first nominal power for approximately 19 seconds and the UV LEDs 2 are subsequently operated for approximately 32 seconds with a pulse width modulation in which the power of the UV LEDs 2 is operated between the first nominal power and a lower second nominal power at uniform frequency.

A plurality of different programs for controlling the power over time are stored for the blue LEDs 1 and the UV LEDs 2 in the microcontroller 6. The programs can be selected or performed with the aid of the computer 12 or respectively the input device 12. The programs preferably differ due to the duration of the power stages, the frequency of the pulse width modulation, the gradient and the form of the ramps during increases in power and reductions in power as well as due to the power of the power stages and nominal powers of the blue LEDs 1 and the UV LEDs 2. The programs are thereby matched to the dental polymerization composite resin 11 to be polymerized and cured and can also depend on the geometrical form of the material to be cured.

The suitable courses of the program can be empirically determined in that the respective dental polymerization composite resin 11 is polymerized and cured with a particular test program and subsequently the hardness of the material and, in particular, also the curing depth are determined, that is to say the depth up to which the dental polymerization composite resin 11 is polymerized and cured up to a particular degree. By comparing these measuring results with respect to hardness and/or curing depth during different test programs, the best suited test program can be found for the respective dental polymerization composite resin 11 and can be deposited in the SPC 6. The program is then selectable, for example, by means of an obvious identifier via the computer 12 or respectively the input device 12.

A freely programmable microcontroller 6 can also be used, which makes it possible to define a separate program. To this end, program modules can be deposited in a memory in a modular manner, which can be selected and put together in order to create separate programs. Ramps, gradients, time steps, masking, flashing, post-curing or cooling, for example, are possible program modules.

In addition to a purely empirical procedure for determining suitable programs, specific adaptations can also be provided. Thus, thicker or respectively deeper geometrical structures require a larger proportion of blue of the irradiation, since the blue irradiation penetrates deeper into the material. If a dental polymerization composite resin 11 having a larger quantity or respectively a higher density of dispersing particles, which influence the aesthetic appearance of the dental polymerization composites resin 11, is used, the UV light can be irradiated as of a later point in time, in order to provide the blue light with an opportunity, ahead of this, of reaching the deeper regions of the dental polymerization composite resin 11 for a longer period of time. In addition, the power can then be reduced, in order to give the deeper regions more time for polymerizing and curing.

The features of the invention which are disclosed in the foregoing description as well as the claims, figures and embodiment examples can be essential, both individually and in any combination, for the realization of the invention in its various embodiments.

### LIST OF REFERENCE NUMERALS

1 Blue LED

2 Ultraviolet or near-UV LED

3 Fan

4 Fan

6 Microcontroller

8 Reflector pot with dental polymerization composite resin

11 Dentures/dental polymerization composite resin

12 Input device/Computer

14 Rotary plate

16 Motor

1. A method for polymerizing and curing a dental polymerization composite resin using a light irradiating device, said light irradiating device comprising at least one blue LED with an emission peak at a wavelength between 430 nm and 490 nm and at least one ultraviolet or near-UV LED with an emission peak between 350 nm and 420 nm, the method comprising:
first operating the at least one blue LED without the at least one ultraviolet or near-UV LED, and operating the at least one ultraviolet or near-UV LED later, wherein a power of the at least one blue LED and a power of the at least one ultraviolet or near-UV LED are controlled in a programmed manner based on time, and irradiating light irradiated from the at least one blue LED and the at least one ultraviolet or near-UV LED of the light irradiating device onto the dental polymerization composite resin, wherein the dental polymerization composite resin is thereby polymerized and cured.

2. The method according to claim 1, wherein the programmed controller produces a software-modulated and/or a hardware-modulated power control of the at least one blue LED and/or of the at least one ultraviolet or near-UV LED.

3. The method according to claim 1, comprising operating the at least one blue LED and/or the at least one ultraviolet or near-UV LED periodically at least at times.

4. The method according to claim 1, comprising increasing and/or reducing the power of the at least one blue LED and/or of the at least one ultraviolet or near-UV LED in a controlled manner based on time by at least one power ramp.

5. The method according to claim 1, comprising starting the program for temporally controlling the power of the at least one blue LED and/or of the at least one ultraviolet or near-UV LED by operating an operating element of the light irradiating device or of an input device or of a computer which is connected to the light irradiating device or which is a part of the light irradiating device.

6. The method according to claim 1, comprising using a camphorquinone and a tertiary amine or an acylphosphine oxide or diphenyl (2,4,6-trimethylbenzoyl) phosphine oxide (TPO) or 1-phenylpropane-1,2-dione (PPD) as a photopolymerization catalyst of the dental polymerization composite resin to polymerize and cure the dental polymerization composite resin.

7. The method according to claim 1, comprising depositing or storing a plurality of different programs for temporally controlling the power of the at least one blue LED and of the at least one ultraviolet or near-UV LED in the light irradiating device, and selecting a program by an input, by operating an operating element, by scanning a code or a label, and/or by a measurement with at least one sensor.

8. The method according to claim 1, comprising controlling the power of the at least one blue LED and/or of the at least one ultraviolet or near-UV LED with a programmed pulse width modulation.

9. The method according to claim 1, comprising controlling the power of the at least one blue LED and the power of the at least one ultraviolet or near-UV LED in a programmed manner based on time in such a manner that the operation of the at least one blue LED starts first and the operation of the at least one ultraviolet or near-UV LED starts thereafter and the operation of the at least one blue LED is ended prior to or at the same time as the operation of the at least one ultraviolet or near-UV LED.

10. The method according to claim 1, wherein the light irradiating device has at least one fan for air cooling the LED.

11. The method according to claim 1, wherein the light irradiating device has a motor for rotating a rotary plate, wherein the rotary plate is arranged in an irradiation region of the light irradiating device and the dental polymerization composite resin is arranged on the rotary plate to cure the dental polymerization composite resin.

12. The method according to claim 1, comprising adjusting at least two different nominal powers greater than 0 Watt during the programmed control of the power of the at least one blue LED and/or of the at least one ultraviolet or near-UV LED.

13. The method according to claim 1, comprising irradiating at least a part of the light of the at least one blue LED and/or of the at least one ultraviolet or near-UV LED which does not directly hit the dental polymerization composite resin with the aid of a reflector or with the aid of a plurality of reflectors onto the dental polymerization composite resin.

14. The method according to claim 1, wherein the light irradiating device has an irradiation opening for irradiating the light of the at least one blue LED and of the at least one ultraviolet or near-UV LED having an area of at least 10 cm²,

15. The method according to claim 1, wherein the dental polymerization composite resin is arranged on a carrier element, and the method comprises irradiating the dental polymerization composite resin located on the carrier element with the light irradiating device.

16. The method according to claim 1, comprising first operating the at least one blue LED without the at least one ultraviolet or near-UV LED and switching on the at least one ultraviolet or near-UV LED later, so that the at least one blue LED and the at least one ultraviolet or near-UV LED are operated at the same time at least at times as of a later point in time.

17. A light irradiating device for polymerizing and curing a dental polymerization composite resin, said light irradiating device having at least one blue LED with an emission peak at a wavelength between 430 nm and 490 nm and at least one ultraviolet or near-UV LED with an emission peak between 350 nm and 420 nm, and a controller for temporally controlling the power of the at least one blue LED and for temporally controlling the power of the at least one ultraviolet or near-UV LED independently of each other, wherein the controller is designed to carry out a method according to claim 1.

18. The light irradiating device according to claim 17, wherein the light irradiating device has at least two blue LEDs with an emission peak at a wavelength between 430 nm and 490 nm and the light irradiating device has at least twice as many of the at least two blue LEDs as the at least one ultraviolet or near-UV LED.

19. The light irradiating device according to claim 17, wherein the at least one blue LED is constructed as multiple groups of two to twenty series-connected blue LEDs and the at least one ultraviolet or near-UV LED is constructed as at least one group of two to twenty series-connected ultraviolet or near-UV LEDs.

20. The method according to claim 3, comprising controlling the frequency in a programmed manner.

21. The method according to claim 4, comprising increasing and/or reducing the power within a period of at least 1 second and a maximum of 300 seconds from a first power to a second power and/or the at least one power ramp is controlled with a linear, logarithmic, or exponential time-dependent course or with a passage of time which follows another mathematical function.

22. The method according to claim 5, comprising starting the program for temporally controlling the power of the at least one blue LED and/or of the at least one ultraviolet or near-UV LED by operating a switch, a button, a rotary pulse generator, a keyboard, a voice control, a touchscreen, or a lever of the light irradiating device or of the computer.

23. The method according to claim 7, wherein the measurement is effected with at least one sensor by an analysis of the dental polymerization composite resin or of at least one of the components of the dental polymerization composite resin.

24. The method according to claim 10, wherein the light irradiating device has one fan for air cooling of the at least one blue LED, and has a fan for air cooling of the at least one ultraviolet or near-UV LED, wherein the at least one fan is driven by at least one motor which is controlled in a programmed manner similarly to the controller of the power of the at least one blue LED and/or of the at least one ultraviolet or near-UV LED.

25. The method according to claim 11, wherein the motor for rotating a rotary plate is preferably controlled in a programmed manner.

26. The method according to claim 14, wherein the light irradiating device has an irradiation opening for irradiating the light of the at least one blue LED and of the at least one ultraviolet or near-UV LED having an area of at least 100 cm².

27. The method according to claim 15, wherein a dental model or a framework is used as the carrier model.

28. The light irradiating device according to claim 18, wherein the light irradiating device has at least four times as many of the at least one blue LED as the at least one ultraviolet or near-UV LED.
